(19) United States
(12) Patent Application Publication
(10) Pub. No.: US 2024/0124336 A1
(43) Pub. Date: Apr. 18, 2024

(54) HIGH-EFFICIENT MAGNESIUM ION REMOVAL SYSTEM FOR SALT LAKE BRINE BASED ON IN SITU ALKALI PRODUCTION USING BIPOLAR MEMBRANE ELECTROCHEMICAL PROCESS

(71) Applicant: DALIAN UNIVERSITY OF TECHNOLOGY, Dalian, Liaoning (CN)

(72) Inventors: Xuehua RUAN, Dalian, Liaoning (CN); Xiaobin JIANG, Dalian, Liaoning (CN); Gaohong HE, Dalian, Liaoning (CN); Xiaoming YAN, Dalian, Liaoning (CN); Wanting CHEN, Dalian, Liaoning (CN); Xuemei WU, Dalian, Liaoning (CN); Yan DAI, Dalian, Liaoning (CN); Tiantian LI, Dalian, Liaoning (CN); Miao YU, Dalian, Liaoning (CN)

(21) Appl. No.: 18/043,670

(22) PCT Filed: Aug. 8, 2022
(86) PCT No.: PCT/CN2022/110742

§ 371 Date: Mar. 1, 2023

(30) Foreign Application Priority Data
Mar. 9, 2022 (CN) 202210229588.2

(51) Int. Cl. C02F 1/469; C02F 1/42

(52) U.S. Cl. CPC C02F 1/4693; C02F 1/42; C02F 2101/10

(57) ABSTRACT

The present invention provides a high-efficient magnesium ion removal system for salt lake brine based on in situ alkali production using bipolar membrane electrochemical process, it is constructed with cathode, cathode cell, anode, anode cell, and anion exchange membranes, bipolar membranes, acid cells, alkali cells, mesh materials for precipitate aggregation, acid-washing cells. During the working stage, salt lake brine enters the alkali cell, in which magnesium ions react with hydroxide groups and generate precipitate in mesh materials for precipitate aggregation, meanwhile magnesium-removed salt lake brine is produced; pure water enters acid cell, in which hydrochloric acid is produced and then exported to acid-washing cell; the mesh materials for precipitate aggregation, after they are packed with magnesium hydroxide particles, would be periodically transferred into acid-washing cell, in which magnesium hydroxide would react with hydrochloric acid and generate magnesium chloride solution, and the mesh materials are recycled after regeneration for precipitate aggregation.

### TECHNICAL FIELD OF THE INVENTION

The present invention relates to a high-efficient magnesium ion removal system for salt lake brine based on in situ alkali production using bipolar membrane electrochemical process, which is belonging to the chemical engineering field.

### BACKGROUND OF THE INVENTION

Salt lake is a kind of saline water reservoirs existing on land, usually referring to the lakes in which the equivalent salt concentration is greater than 3.5 wt %, and also including the dried-up salt lakes which contain saline deposit and inter-crystalline brine, but without the brine under free state. The mother solution after salt manufacturing from salt lake water, so-called salt lake brine, contains nearly 200 kinds of saline minerals; hereinto, the main mineral components are magnesium chloride, lithium chloride, calcium chloride, calcium sulfate and sodium chloride. Overall, the salt lake brine is an important raw material able to generate many chemical products, e.g., mirabilite, potassium, lithium, magnesium, boron, bromine, saltpeter and gypsum.

Lithium salt is the most important strategic resource in salt lake brine, which is irreplaceable in many fields, e.g., energy, materials, information, medicine and military industries. In recent years, lithium salt demands are going on increasing with the rapid development in lithium-batteries-based energy storage devices, and the price would be remaining at a high level for a long term. The price of battery grade lithium carbonate in China reaches 113,000 yuan/ton. Although the proven reserves equivalent with lithium carbonate exceed 99 million tons around the world, the supplied quantity, subject to the difficulties in concentrating and purification during mining process, is limited extremely. According to statistics, the mining output equivalent with lithium carbonate is only about 470,000 tons in 2021 and results in serious rising in price around the world.

China is a country with rich lithium resources. According to the statement of the China Geological Survey, the lithium resource reserves in China are 7.14 million tons of equivalent weight of lithium carbonate, where the lithium resource reserves in salt lakes account for more than 80% of the total reserves. During the common mining process for lithium resources in salt lakes, the first operation step is adding appropriate amounts of sodium carbonate into the brine, so that the impurities including magnesium, calcium and barium ions are removed by precipitation (converted into carbonate salts with extremely low solubility, 0.02 g, 0.00053 g and 0.0014 g in 100 g water, respectively), and the second operation step is adding excess sodium carbonate into the salt lake brine, so that lithium ions could be converted into slightly soluble lithium carbonate precipitate (1.29 g in 100 g water). This compact technology is efficient for many classical salt lake brine cases in the international markets, e.g., the reserves in Chile, Argentina, Australia, and USA; nevertheless, this technology is restricted seriously in the face of the salt lake brine with ultra-high ratio between magnesium and lithium. For instance, this determinant index is about 50 in the reserves in China, 20-40 times higher than that of the international reserves. During the precipitation process to remove impurities such as magnesium ions, a large number of lithium ions would be converted into lithium carbonate precipitate and result in a serious loss in resources. Many lithium reserves in China, subject to the limit around high ratio between magnesium and lithium, cannot be exploited effectively. The lithium reserves in salt lakes account for more than 80% of the total reserves in China; nevertheless, the lithium products from salt lake brine can only account for 8.0% of the total mining output in China. In order to make environmental-friendly and efficient utilization of lithium resources in salt lake brine, high-efficient and high-selective magnesium removal method is urgently required.

After studying magnesium element thoroughly around its physical and chemical properties, the researchers find that it is better to combine magnesium ions and hydroxide groups into precipitate under basic condition. In 100 g water at ambient temperature, magnesium hydroxide solubility is 0.00084 g, and lithium hydroxide solubility is 11.2 g. In other words, sodium hydroxide can achieve the precipitation process for removing magnesium ions with much less loss in lithium resources. It is expectable that the sodium-hydroxide-based route can overcome the bottleneck about the efficient utilization of salt lake brine with high ratio between magnesium and lithium.

Many previous researches revealed that the sodium-hydroxide-based routes using conventional reactors for precipitation have some defects for removing magnesium ions in the salt lake brine. The basic problem is the inferior mixing efficiency in microscopic scale about adding sodium hydroxide solution into salt lake brine as the precipitation agent. It is very difficult to make meticulous control for the supersaturated concentration of hydroxide groups; in this instance, the precipitated particles of magnesium hydroxide are small in size and easy to be gelled, and then difficult to be removed. It is obvious that such a situation is adverse for the continuous and large-scale process around lithium products. In addition, sodium hydroxide is more expensive than sodium carbonate, which would further increase the cost of removing magnesium ions from brine.

With the intent to overcome the shortages mentioned above, the present invention proposes a high-efficient magnesium ion removal system for salt lake brine based on in situ alkali production using bipolar membrane electrochemical process. The major advantages of the invention: hydroxide groups produced by the bipolar membrane could enter the alkali cell homogeneously on both time and space aspects; hydroxide group concentration in the alkali cell can be sensitively controlled by tuning electric voltage; hydroxide groups and magnesium ions driven by direct-current electric field would migrate in opposite directions in the alkali cell, so that magnesium hydroxide particles would be generated in the mesh materials arranged specially for precipitate aggregation, and membrane fouling can be reduced greatly during magnesium ion removal; the by-product in bipolar membrane system, i.e., hydrochloric acid, can be used to regenerate mesh materials for precipitate aggregation without adding any extra components into salt lake brine; the handling procedures around sodium hydroxide, such as transport, storage, solution preparation and charge, could be avoided through in situ alkali production using electrochemical process, so that the production costs for magnesium ion removal could be greatly reduced.

### SUMMARY OF THE INVENTION

The present invention provided a high-efficient magnesium ion removal system for salt lake brine based on in situ alkali production using bipolar membrane electrochemical process. The bipolar membrane system in the present invention is composed with the following pivotal units: a cathode, an anode, a cathode cell, an anode cell, bipolar membranes, anion exchange membranes, mesh materials for precipitate aggregation, acid cells, alkali cells and acid-washing cells. Salt lake brine enters the alkali cells, in which magnesium ions will react with hydroxide groups and generate magnesium hydroxide precipitate in the mesh materials for precipitate aggregation, and thereupon magnesium-removed salt lake brine is produced; pure water enters the acid cells, in which chloride ions would be mixed with protons and generate hydrochloric acid, and then the acid solution enters the acid-washing cells; the mesh materials for precipitate aggregation are periodically transferred from the alkali cells to the acid-washing cells, in which magnesium hydroxide would be dissolved into magnesium chloride solution, and the mesh materials will be recycled after regeneration. The definite and specific scheme to achieve high-efficient magnesium ion removal for salt lake brine based on in situ alkali production is as follows:

A high-efficient magnesium ion removal system for salt lake brine based on in situ alkali production using bipolar membrane electrochemical process, wherein:
the single-channel bipolar membrane unit with one module generating acid and alkali solutions simultaneously is constructed by assembling a cathode 1, a cathode cell 2, an anion exchange membrane 3, an acid cell 4, a bipolar membrane 5, an alkali cell 6, an anion exchange membrane 3, an anode cell 7 and an anode 8 in sequence; in addition, the outstretched mesh materials for precipitate aggregation 9 are inserted into the alkali cell 6 with the layout parallel to the bipolar membrane 5, and the outlet of the acid cell 4 is connected with an acid-washing cell 10;
the multi-channel bipolar membrane unit is formed by inserting multiple modules generating acid and alkali solutions simultaneously between the anion exchange membrane 3 and the anode cell 7 in the single-channel bipolar membrane unit; each module simultaneously generating acid and alkali solutions is constructed by assembling an acid cell 4, a bipolar membrane 5, an alkali cell 6 and an anion exchange membrane 3 in sequence, and then the outstretched mesh materials for precipitate aggregation 9 are inserted into the alkali cell 6 with the layout parallel to the bipolar membrane, and the outlet of the acid cell 4 is connected with an acid-washing cell 10;
during the working stage of the bipolar membrane system with in situ alkali production and high-efficient magnesium ion removal from salt lake brine, sodium chloride aqueous solution S-1 is fed into the cathode cell 2, in which aqueous solution containing sodium hydroxide and sodium chloride S-4 is generated, meanwhile chloride ions are driven away by direct-current electric field and permeate across the anion exchange membrane 3 and into the acid cell 4; pure water S-2 is fed into the acid cell 4, in which chloride ions permeating across the anion exchange membrane 3 would be mixed with protons produced by the bipolar membrane 5 and generate hydrochloric acid S-5, and then hydrochloric acid is fed into the acid-washing cell 10; salt lake brine S-3 is fed into the alkali cell 6, in which magnesium ions would be reacted with hydroxide groups produced by the bipolar membrane 5 and generate magnesium hydroxide particles hardly soluble in water in the mesh materials for precipitate aggregation 9, and magnesium-removed salt lake brine S-6 is produced simultaneously; the mesh materials for precipitate aggregation 9 in the alkali cell 6 are periodically replaced, while the replaced mesh materials for precipitate aggregation 9, which have been packed with magnesium hydroxide particles, are transferred into the acid-washing cell 10, in which magnesium hydroxide is dissolved into magnesium chloride solution, and the mesh materials for precipitate aggregation 9 will be recycled after regeneration.

The present invention has the following beneficial effects: hydroxide group concentration in the alkali cell can be sensitively controlled by tuning electric voltage; hydroxide groups produced by the bipolar membrane could enter the alkali cell homogeneously on both time and space aspects; hydroxide groups and magnesium ions will migrate in opposite directions in the alkali cell under the driving from direct-current electric field, so that magnesium hydroxide particles would be generated in the mesh materials arranged specially for precipitate aggregation, and membrane fouling can be reduced greatly during magnesium ion removal; the critical problems around magnesium hydroxide precipitation and separation using the direct mixing process of alkali liquor, e.g., small particle size, easy gelling, and difficult particle removal, can be avoided through electric-voltage-based accurate tuning for hydroxide group concentration together with mesh-materials-assisted step-by-step growth for precipitate aggregation; the by-product in bipolar membrane system, i.e., hydrochloric acid, can be used to regenerate mesh materials for precipitate aggregation without adding extra components into salt lake brine; the handling procedures around sodium hydroxide, such as transport, storage, solution preparation and charge, can be avoided by in situ alkali production using electrochemical process, so that the production costs for magnesium ion removal could be greatly reduced.

According to the experimental results using the innovative method in the present invention to process the salt lake brine with high ratio between magnesium and lithium, magnesium ions can be removed efficiently by more than 98%, and the loss of lithium ions could be controlled to be lower than 0.5%; meanwhile, the operation cost could be saved by about 30˜40% in comparison with the precipitation scheme directly using external sodium hydroxide as precipitation agent. On the whole, the high-efficient magnesium ion removal system based on in situ alkali production using bipolar membrane electrochemical process is highly promising to overcome the bottleneck which limit the efficient utilization of salt lake brine with high ratio between magnesium and lithium.

### BRIEF DESCRIPTION OF THE DRAWINGS

FIG. 1 is the schematic diagram of the single-channel bipolar membrane system for high-efficient magnesium ion removal from salt lake brine based on in situ alkali production.

FIG. 2 is the schematic diagram of the binary-channel bipolar membrane system for high-efficient magnesium ion removal from salt lake brine based on in situ alkali production.

Symbols and numbers in the figures: 1 cathode; 2 cathode cell; 3 anion exchange membrane; 4 acid cell; 5 bipolar membrane; 6 alkali cell; 7 anode cell; 8 anode; 9 mesh materials for precipitate aggregation; 10 acid-washing cell; S-1 sodium chloride aqueous solution; S-2 pure water; S-3 salt lake brine; S-4 aqueous solution containing sodium hydroxide and sodium chloride; S-5 hydrochloric acid; S-6 magnesium-removed salt lake brine.

### DETAILED DESCRIPTION OF THE INVENTION

Specific embodiments of the present invention are further described on the basis of the attached drawings and the technical solution.

### Embodiment 1

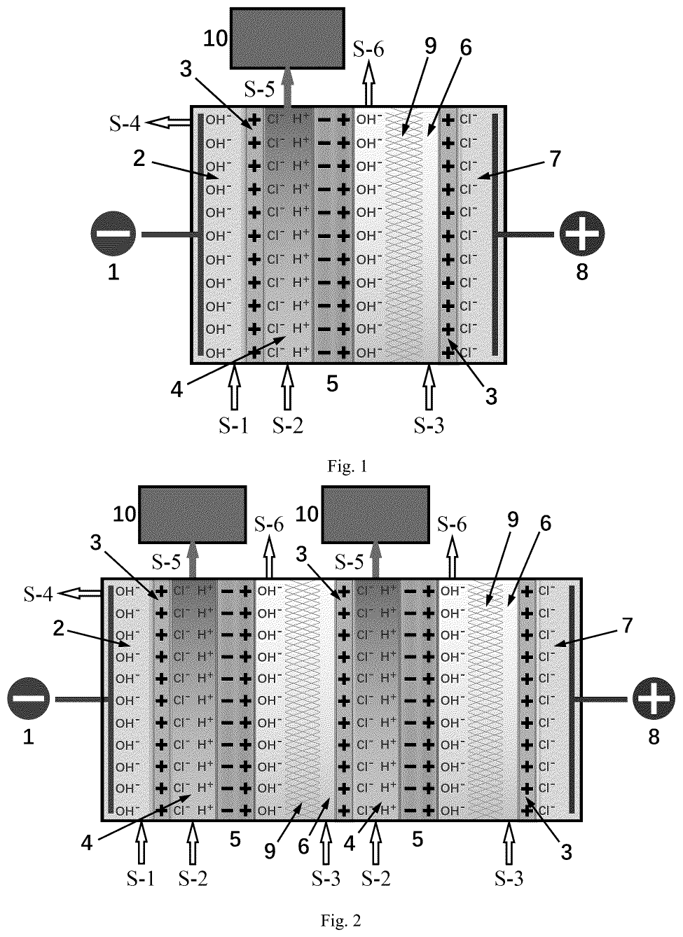

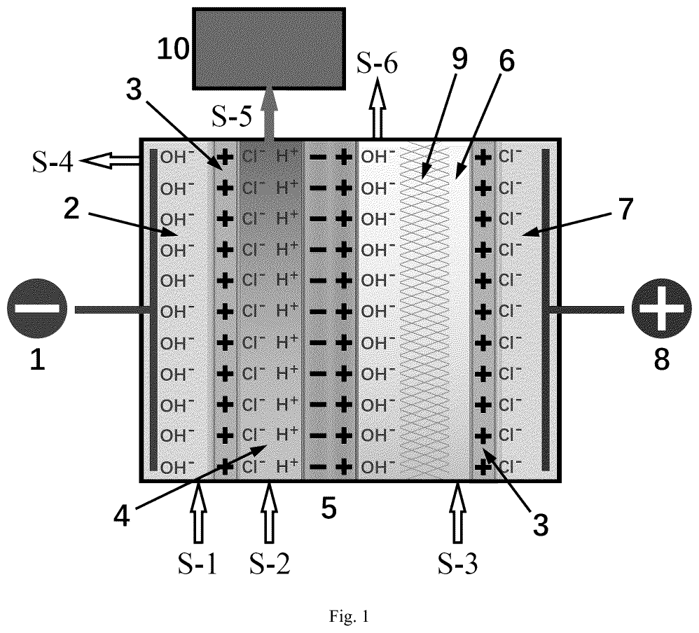

The single-channel bipolar membrane system, with the structure exhibited in FIG. 1, is utilized to undertake the electrochemical process for in situ alkali production and then achieve high-efficient magnesium ion removal from the salt lake brine. During the working stage, sodium chloride aqueous solution S-1 is fed into the cathode cell 2, in which aqueous solution containing sodium hydroxide and sodium chloride S-4 is generated, meanwhile chloride ions are driven away by direct-current electric field and permeate across the anion exchange membrane 3 and into the acid cell 4; pure water S-2 is fed into the acid cell 4, in which chloride ions permeating across the anion exchange membrane 3 would mix with protons produced by the bipolar membrane 5 to generate hydrochloric acid S-5, and thereafter hydrochloric acid is fed into the acid-washing cell 10; salt lake brine S-3 is fed into the alkali cell 6, in which magnesium ions are reacted with hydroxide groups produced by the bipolar membrane 5 and generate magnesium hydroxide particles hardly soluble in water in the mesh materials for precipitate aggregation 9, and then the magnesium-removed salt lake brine S-6 is produced simultaneously; the mesh materials for precipitate aggregation 9 in the alkali cell 6, after they are packed with magnesium hydroxide particles, would be periodically replaced and transferred into the acid-washing cell 10, in which magnesium hydroxide is dissolved into magnesium chloride solution, and the mesh materials for precipitate aggregation 9 will be recycled after regeneration. In the Embodiment 1, the salt lake brine is fed with the molar ratio of magnesium ions to lithium ions in the range between 60 and 65. Under the normal working status, the single-channel bipolar membrane system is running with the direct-current electric voltage equal to 1.15 V and the current density correspondingly equal to 800 A/m², respectively. In this instance, the energy consumption measured with electricity is about 2300 kWh/ton sodium hydroxide through in situ alkali production, and the specific consumption is about 4000 kWh/ton magnesium hydroxide precipitate. In the case converting the precipitate into simple substance, the specific consumption is about 9600 kWh/ton magnesium. According to the separation result of the innovative method in the present invention for Embodiment 1, magnesium ions could be removed by more than 99.0%, the loss of lithium ions is less than 0.5%, and the molar ratio of magnesium ions to lithium ions can be reduced to 0.60 in the purified salt lake brine. In addition, the by-product magnesium chloride can be yielded with purity higher than 98.0 wt %.

### Embodiment 2

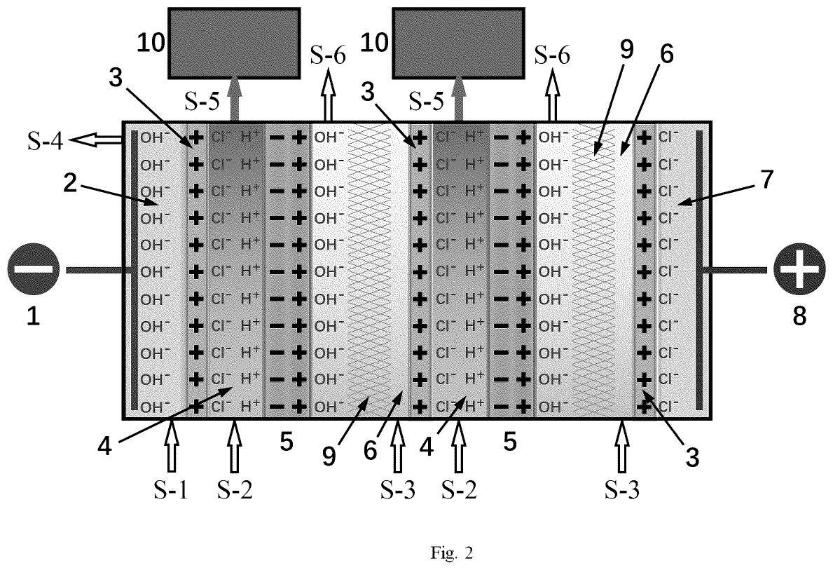

The binary-channel bipolar membrane system, with the structure exhibited in FIG. 2, is utilized to undertake the electrochemical process for in situ alkali production and then achieve high-efficient magnesium ion removal from the salt lake brine. During the working stage, sodium chloride aqueous solution S-1 is fed into the cathode cell 2, in which aqueous solution containing sodium hydroxide and sodium chloride S-4 is generated, meanwhile chloride ions are driven away by direct-current electric field and permeate across the anion exchange membrane 3 and into the acid cell 4; pure water S-2 is fed into the acid cell 4, in which chloride ions permeating across the anion exchange membrane 3 would mix with protons produced by the bipolar membrane 5 to generate hydrochloric acid S-5, and thereafter hydrochloric acid is fed into the acid-washing cell 10; salt lake brine S-3 is fed into the alkali cell 6, in which magnesium ions are reacted with hydroxide groups produced by the bipolar membrane 5 and generate magnesium hydroxide particles hardly soluble in water in the mesh materials for precipitate aggregation 9, and then the magnesium-removed salt lake brine S-6 is produced simultaneously; the mesh materials for precipitate aggregation 9 in the alkali cell 6, after they are packed with magnesium hydroxide particles, would be periodically replaced and transferred into the acid-washing cell 10, in which magnesium hydroxide is dissolved into magnesium chloride solution, and the mesh materials for precipitate aggregation 9 will be recycled after regeneration.

In the Embodiment 2, the salt lake brine is fed with the molar ratio of magnesium ions to lithium ions in the range between 35 and 40. Under the normal working status, the binary-channel bipolar membrane system is running with the direct-current electric voltage equal to 2.10 V and the current density correspondingly equal to 750 A/m², respectively. In this instance, the energy consumption measured with electricity is about 2100 kWh/ton sodium hydroxide through in situ alkali production, and the specific consumption is about 3700 kWh/ton magnesium hydroxide precipitate. In the case converting the precipitate into simple substance, the specific consumption is about 8900 kWh/ton magnesium. According to the separation result of the innovative method in the present invention for Embodiment 2, magnesium ions could be removed by more than 98.7%, the loss of lithium ions is less than 0.5%, and the molar ratio of magnesium ions to lithium ions can be reduced to 0.55 in the purified salt lake brine. In addition, the by-product magnesium chloride can be yielded with purity higher than 98.0 wt %.

### Embodiment 3

The decuple-channel bipolar membrane system is used to conduct the electrochemical process for in situ alkali production and then achieve high-efficient magnesium ion removal from the salt lake brine. During the working stage, sodium chloride aqueous solution S-1 is fed into the cathode cell 2, in which aqueous solution of sodium hydroxide and sodium chloride S-4 is generated, meanwhile chloride ions would be driven away by direct-current electric field and permeate across the anion exchange membrane 3 and into the acid cell 4; pure water S-2 is fed into the acid cell 4, in which chloride ions permeating across the anion exchange membrane 3 would mix with protons produced by the bipolar membrane 5 to generate hydrochloric acid S-5, and thereafter hydrochloric acid is fed into the acid-washing cell 10; salt lake brine S-3 is fed into the alkali cell 6, in which magnesium ions are reacted with hydroxide groups produced by the bipolar membrane 5 and form magnesium hydroxide particles hardly soluble in water in the mesh materials for precipitate aggregation 9, and then the magnesium-removed salt lake brine S-6 is produced simultaneously; the mesh materials for precipitate aggregation 9 would be periodically transferred from the alkali cell 6 to the acid-washing cell 10 after they are packed with magnesium hydroxide particles, and then magnesium hydroxide is dissolved into magnesium chloride in the aqueous solution, meanwhile the mesh materials 9 will be recycled after regeneration for precipitate aggregation.

In the Embodiment 3, the salt lake brine is fed with the molar ratio of magnesium ions to lithium ions in the range between 60 and 65. Under the normal working status, the binary-channel bipolar membrane system is running with the direct-current electric voltage equal to 9.25 V and the current density correspondingly equal to 720 A/m², respectively. In this instance, the energy consumption measured with electricity is about 1850 kWh/ton sodium hydroxide through in situ alkali production, and the specific consumption is about 3200 kWh/ton magnesium hydroxide precipitate. In the case converting the precipitate into simple substance, the specific consumption is about 7700 kWh/ton magnesium. According to the separation result of the innovative method in the present invention for Embodiment 2, magnesium ions could be removed by more than 99.0%, the loss of lithium ions is less than 0.5%, and the molar ratio of magnesium ions to lithium ions can be reduced to 0.60 in the purified salt lake brine. In addition, the by-product magnesium chloride can be yielded with purity higher than 98.0 wt %.

1. A high-efficient magnesium ion removal system for salt lake brine based on in situ alkali production using bipolar membrane electrochemical process, wherein:
the single-channel bipolar membrane unit with one module generating acid and alkali solutions simultaneously is constructed by assembling a cathode, a cathode cell, an anion exchange membrane, an acid cell, a bipolar membrane, an alkali cell, an anion exchange membrane, an anode cell and an anode in sequence; in addition, the outstretched mesh materials for precipitate aggregation are inserted into the alkali cell with the layout parallel to the bipolar membrane, and the outlet of the acid cell is connected with an acid-washing cell;
the multi-channel bipolar membrane unit is formed by inserting multiple modules generating acid and alkali solutions simultaneously between the anion exchange membrane and the anode cell in the single-channel bipolar membrane unit; each module simultaneously generating acid and alkali solutions is constructed by assembling an acid cell, a bipolar membrane, an alkali cell and an anion exchange membrane in sequence, and then the outstretched mesh materials for precipitate aggregation are inserted into the alkali cell with the layout parallel to the bipolar membrane, and the outlet of the acid cell is connected with an acid-washing cell;
during the working stage of the bipolar membrane system with in situ alkali production and high-efficient magnesium ion removal from salt lake brine, sodium chloride aqueous solution is fed into the cathode cell, in which aqueous solution containing sodium hydroxide and sodium chloride is generated, meanwhile chloride ions are driven away by direct-current electric field and permeate across the anion exchange membrane and into the acid cell; pure water is fed into the acid cell, in which chloride ions permeating across the anion exchange membrane would be mixed with protons produced by the bipolar membrane and generate hydrochloric acid, and then hydrochloric acid is fed into the acid-washing cell; salt lake brine is fed into the alkali cell, in which magnesium ions would be reacted with hydroxide groups produced by the bipolar membrane and generate magnesium hydroxide particles hardly soluble in water in the mesh materials for precipitate aggregation, and magnesium-removed salt lake brine is produced simultaneously; the mesh materials for precipitate aggregation in the alkali cell are periodically replaced, while the replaced mesh materials for precipitate aggregation, which have been packed with magnesium hydroxide particles, are transferred into the acid-washing cell, in which magnesium hydroxide is dissolved into magnesium chloride solution, and the mesh materials for precipitate aggregation will be recycled after regeneration.
